(19) United States
(12) Patent Application Publication
(10) Pub. No.: US 2020/0264987 A1
(43) Pub. Date: Aug. 20, 2020

(54) OBJECT CACHE CANDIDATE FILTER

(71) Applicant: Hewlett Packard Enterprise Development LP, Houston, TX (US)

(72) Inventors: Glenn S. Watkins, Westborough, MA (US); John Michael Czerkowicz, Westborough, MA (US); Sumit Narayan, Westborough, MA (US); Peter William Madany, Westborough, MA (US)

(21) Appl. No.: 16/281,006

(22) Filed: Feb. 20, 2019

(51) Int. Cl. G06F 12/126; G06F 12/0871; G06F 12/128

(52) U.S. Cl. CPC G06F 12/126; G06F 12/128; G06F 12/0871

(57) ABSTRACT

A system and method for an object cache candidate filter comprising identifying a first portion and a second portion of an object signature, determining a bucket of a candidate data structure to associated with the object signature based on a first portion of the object signature, comparing the second portion of the object signature to each of a plurality of entries of the determined bucket of the candidate data structure, and, in response to determining no entry of the plurality of entries matches the second portion of the signature, the candidate filter storing the second portion of the object signature in an open entry of the determined bucket.

### BACKGROUND

Caching provides performance increases by reducing the processing expense necessary to access frequently accessed data from underlying slower storage. Hardware and/or software caches maintain a copy of data that is commonly used closer to the processes and/or programs of the system in an intermediate storage, thereby reducing the need to retrieve data from a slower storage device or recompute data for repeat use. Commonly, caches utilize faster storage media (e.g., flash, dynamic random access memory (“DRAM”), solid state drive (“SSD”)) to provide faster access than traditional disk drives (e.g., hard disk drive (“HDD”)).

To achieve efficiency increases, cache size must be relatively small. The size of a cache is generally a small fraction of the total storage size of the system. Accordingly, eviction or replacement policies are utilized to change the data stored in the cache, such as the Least Recently Used (“LRU”) policy that removes the least recently used data item from the cache to store the most recently used data item.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is an example candidate filter in accordance with embodiments of the technology disclosed herein.

FIG. 2 illustrates an example system in accordance with embodiments of the technology disclosed herein.

FIG. 3 shows an example process in accordance with embodiments of the technology disclosed herein.

FIG. 4 is an example computing component in accordance with embodiments of the technology disclosed herein.

FIG. 5 is an example computing system in which embodiments described in the present disclosure may be implemented.

The figures are not exhaustive and do not limit the present disclosure to the precise form disclosed.

### DETAILED DESCRIPTION

One approach to increasing the efficiency of data caches is tracking the number of read access requests for data stored in those data caches. Wasted overhead is introduced by adding data objects to a cache that will not be read again before they will need to be evicted to make room for other objects. A filter helps reduce this waste by tracking a brief history of recent read requests. A data object is not deemed “cacheable” unless the data object has been the subject of multiple read requests, rather than immediately being cached. Requiring more than a single request before information is stored in the cache reduces the potential that more frequently requested data is not prematurely evicted from the cache according to the eviction policy.

Similar to the cache size vis-à-vis the storage size, filters generally comprise a fraction of the size compared to the cache. Generally, filters store only enough data to identify the candidates, rather than storing the data of the candidate. As such, even with the comparatively smaller size of the filter compared with to the cache size, the filter is capable of maintaining identifying data for a greater number of candidates than could be stored at one time in the cache. The filter would apply an eviction policy to identify candidates to evict when the filter is filled and a first request is received for new data. Therefore, a considerable amount of overhead is still introduced through the filter, where candidates may be added which will not receive a subsequent request before they will need to be evicted from the filter.

Caches and cache filters manage stored information through indexing. Unique identifiers are either associated with, or are generated from the data items to be stored, enabling the cache and/or cache filter to identify where in the storage area the data items are maintained.

The indexing implemented in some content addressable caches and filters involves unique identifiers generated from the data items to be stored, which may limit the potential efficiency gain. To provide the uniqueness employed in such approaches, a hash or signature is computed for each data object. For cache efficiency in such approaches, each data object should be uniquely identified within the cache for managing the data in the cache, such as deduplication. In such approaches, the same signature is utilized in the filter to identify which objects have been seen before. The entire signature is added to an entry and checked when a read request is received. Each entry in the filter requires a certain amount of memory to store the signatures for objects recently requested.

Embodiments of the technology disclosed herein increase the efficiency gain associated with cache filters. The disclosed filter embodiments provide a compact data structure to represent a large number of data objects that potentially could be stored in a cache, referred herein as “candidates.” Rather than storing the entire signature used to identify data objects within the cache, candidate filters in accordance with the embodiments discussed herein leverage portions of these same signatures identifying data objects which are generated for other purposes (i.e., other cache management functions). Use of less than the entire signature to identify a data object within the candidate filter enables more candidates to be stored within the same memory footprint, as compared to other filter implementations. Providing a greater number of candidates for caching greatly improves the overall efficiency of the cache beyond that which is attainable with other filter approaches.

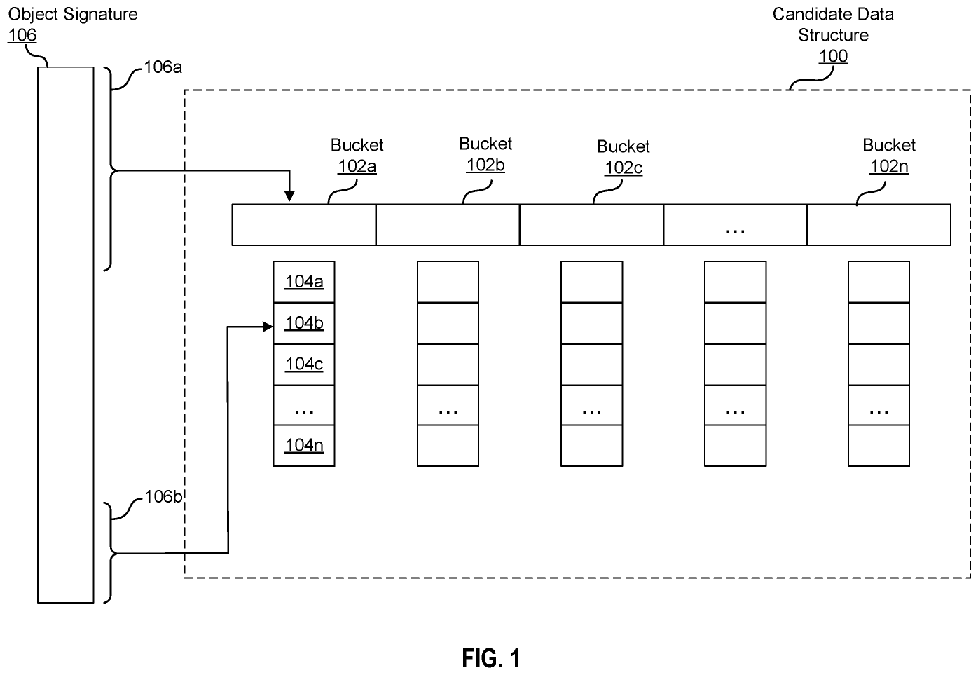

FIG. 1 illustrates an example candidate data structure 100 in accordance with embodiments of the technology disclosed herein. Example candidate data structure 100 is intended as an example, to assist in explaining the technology of the present disclosure, and should not be interpreted as limiting the scope of the technology solely to the candidate data structure 100. A candidate filter in accordance with embodiments of the present disclosure may utilize any candidate filter data structure consistent with the functionality described herein.

As discussed above, signatures are generally used to name and identify data objects in a storage system. A variety of different hashing algorithms or functions exist to generate signatures for data objects, including cryptographic and non-cryptographic hashing algorithms or functions. The embodiments disclosed herein are applicable with any hashing algorithm and provide improved performance over other filter approaches, though with varying degrees of improvement based on the characteristics of the hashing algorithm. Cryptographic hashes generally have an even distribution of randomness, increasing the effectiveness of a candidate data structure 100. For ease of reference, the embodiments of the technology disclosed in the present disclosure will be explained with reference to an object signature generated according to a Secure Hashing Algorithm (“SHA”) cryptographic hash function, specifically SHA-2. Such reference to SHA-2 is meant as an example only and should not be interpreted as limiting the embodiments solely to signatures generated using SHA-2. A person of ordinary skill in the art viewing the present disclosure would know that any other hashing algorithm of sufficient size and providing a uniform distribution of values in a range can be used with the embodiments.

Referring to FIG. 1, candidate data structure 100 includes a number of buckets 102 and entries 104. The number of buckets 102 and entries 104 depends on the implementation specification. In various embodiments, each bucket 102a-102n can be aligned with a CPU memory cache line or block of the cache storage. By aligning each bucket 102a-102n to a cache line or block of storage, an entire lookup operation can be limited to a single memory or storage access, thereby increasing the performance efficiency of the candidate filter. In other embodiments, one or more buckets 102 can be assigned to two or more cache lines. In still other embodiments, the buckets 102 can be unaligned with any particular cache line, instead randomly storing the partial signatures (discussed below) within entries 104.

As illustrated, each bucket 102a-102n of candidate data structure 100 contains at least one entry 104. In some embodiments, the number of entries 104a-104n in any bucket 102 can differ. In some embodiments, a number of entries 104 is a function of (e.g., equal to) the size of the CPU cache line, while in other embodiments less or more entries 104 in relation to the cache line can be used. As will be explained in further detail below, each entry 104a-104n is configured to store an indicator of the data object requested. In various embodiments, candidate data structure 100 may be allocated in one contiguous piece of memory, while in others candidate data structure 100 may be distributed among several smaller memory segments.

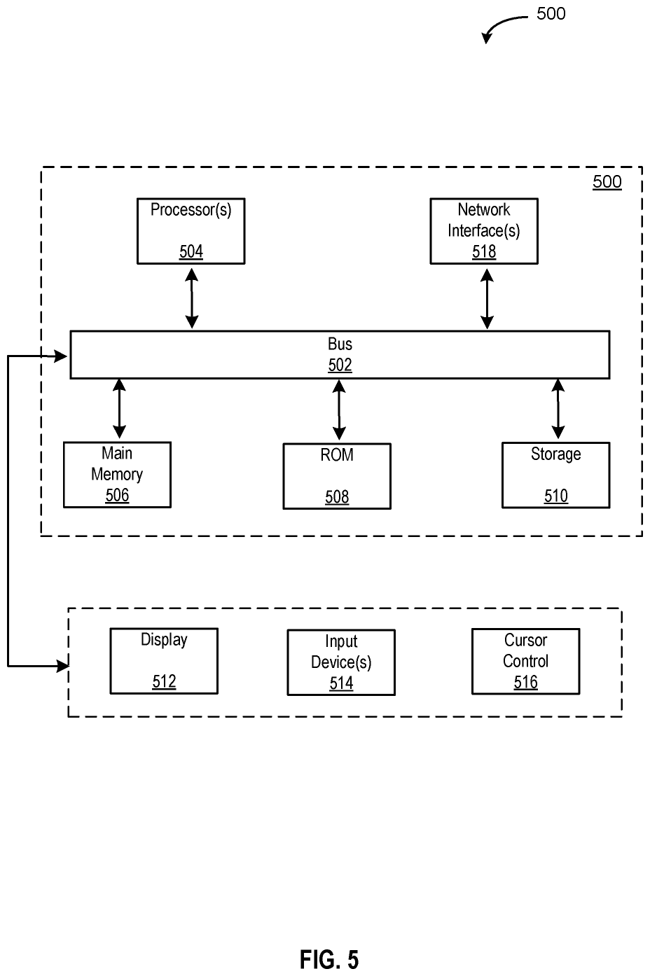

Candidate data structure 100 can be used in conjunction with various different cache types, such as a data object cache, disk cache, web cache, or other caches. In various embodiments, candidate data structure 100 can be associated with a single cache, while in other embodiments candidate data structure 100 can make candidates available to more than one cache in the system. Candidate data structure 100 can be utilized with one or more types of storage media, alone or in combination, such as the storage media discussed below with respect to FIG. 5.

Object signature 106 represents a data object and is used to uniquely identify the data object in the cache. In various embodiments, object signature 106 may be sized within the range of 20-32 bytes, while in other embodiments the size may be outside of that range. The size of object signature 106 can be determined based on the design of the storage system and the needs of the implementation. Candidate filters in accordance with embodiments disclosed herein leverage existing signatures generated for use by the cache manager in uniquely identifying data objects within the cache as well as slower storage media. In FIG. 1, object signature 106 is a cryptographic hash computed from an SHA-2 function. As discussed above this is a non-limiting example of object signature 106.

Object signatures (like object signature 106) provide a high level of uniqueness for effective indexing of data objects, mapping from the logical object signature to the physical location of the object in storage. Cache managers, which are software or hardware components that manage cache operations, use object signatures to perform a variety of management functions, including reducing or eliminating collisions or cache misses and deduplication within the cache.

Unlike embodiments of the candidate filter described herein, other filter approaches apply the same level of uniqueness to the filter as to the cache, storing either the data object itself within an associated data structure or the entire signature identifying the data object. In order for such filters to track, at a minimum, a number of candidates equal to the cache would require the same or similar amount of memory allocated for the data structure of the filter, which is highly inefficient. Accordingly, these other filter data structures hold only a small number of candidates, increasing the probability that a “poor candidate” may evict a “good candidate.” A poor candidate is a data object that, although requested, is not likely to be requested as often as another data object currently in the filter's data structure. Because poor candidates would be added to the data structure when requested by a client or program of the system, the poor candidate could dislodge a good candidate, which is a data object that is likely to be requested more often than the poor candidate. If evicted, rather than the subsequent request for the good candidate resulting in the data object being cached, it would need to be placed back into the filter's data structure again.

By contrast, example embodiments described herein recognize that the level of uniqueness required at the cache level is not required at the filter level. Unlike at the cache level, where a cache miss or misidentification could result in data corruption or processing errors, a miss at the filter level does not result in any data corruption. This is especially true where the filter's data structure is storing only the signatures for the data objects. No data corruption will occur from a miss because the cache manager serves as a backstop to ensure that the filter identified the proper data object to promote. Implementing embodiments of the present disclosure increases the total number of candidates which may be tracked, increasing the likelihood that good candidates will be promoted to the cache over other filter approaches.

Referring again to FIG. 1, a first portion 106a of the object signature 106 is used to identify a bucket 102 of candidate data structure 100 to associate with the data object. In various embodiments, the first portion 106a may be a set number of bytes from the front of object signature 106, from the interior of object signature 106, from the end of object signature 106, or a combination of bytes of object signature 106. The number of bytes of object signature 106 making up the first portion 106a is related to the number of buckets 102 present within candidate data structure 100. In various embodiments, the bucket number of the bucket 102 associated with the data object is computed from the first portion 106a. First portion 106a must contain a sufficient number of bytes such that it is possible to compute up to the number of buckets 102 from the first portion 106a. In various embodiments, the bucket number of the bucket 102 may be determined by performing a modulo operation on the first portion 106a with respect to the total number of buckets.

Associating object signature 106 with a specific bucket 102 based on the first portion 106a can increase the efficiency of the candidate filter by limiting the search to a specific bucket, rather than the entire filter. Moreover, as will be explained in greater detail below, using the first portion 106a in this way helps in avoiding misidentifications of objects.

After the bucket 102 for an object signature 106 is determined, a second portion 106b of the object signature 106 is stored as an entry 104 within the identified bucket 102. In various embodiments, the second portion 106b can comprise less bytes than the first portion 106a, while in other embodiments the second portion 106b and the first portion 106a can have the same number of bytes. In still other embodiments, the second portion 106b can comprise more bytes than the first portion 106a. The determined size of the second portion 106b will further impact the number of data objects which may be tracked in the same footprint. The smaller the size of the second portion 106b, the more data objects can be tracked by enabling more identifiers (i.e., second portions of other object signatures (not pictured)) that can be stored in a bucket 102 due to the increased number of entries 104 available.

As illustrated in FIG. 1, the first portion 106a is computed to identify bucket 102a, and the second portion 106b is selected to store in entry 104b. Upon a subsequent read request being received, the candidate filter can compute a bucket number of the candidate data structure 100 from the first portion 106a of the object signature 106 included in the subsequent request. Based on the result, the candidate filter can then take the second portion 106b of the subsequent object signature 106 and search the entries 104 of the identified bucket 102 of the candidate data structure 100 to see whether the second portion 106b had been previously seen and stored. If there is a match in the candidate data structure, the candidate filter can notify the cache manager to promote the requested data object to the cache. In various embodiments, the candidate filter can return a “true” value indicating that a match was found, and the cache manager can fetch the data object from storage and add it to cache memory or storage blocks. In other embodiments, the candidate filter can send a message to the cache that a match was found. Upon finding a match, the candidate filter in some embodiments can send a fetch message to the storage device with an instruction(s) to return the data object for storage in the cache.

If there is no match, the candidate filter adds the second portion 106b as an entry within the bucket 102 of the candidate data structure 100. Where there is a free entry 104 in the bucket 102, the candidate filter can just add the second portion 106b. If all the entries 104 in the bucket 102 are full, the applies an eviction policy to add the second portion 106b. Non-limiting examples of eviction policies include random eviction, least recently used (LRU), pseudo-LRU, and cache-dependent (where the cache manager managing the object buffers maintains its own replacement algorithm to decide which object can be evicted), among others. Based on the eviction policy employed, candidate filter can select an entry 104 of the candidate data structure in some embodiments which is selected for eviction, remove the current value in the entry 104, and add the new value (the second portion 106b) to the entry 104.

As stated above, embodiments of the present disclosure greatly increase the efficiency of the cache by providing a greater number of candidates to choose from with respect to caching objects. For a non-limiting example, assume that candidate filter data structure 100 is allocated 64 MiB (mebibyte) of memory, each bucket 102a-102n is 64 bytes, and each entry 104a-104n is 4 bytes (and, correspondingly, the second portion 106b is 4 bytes long). In this example, the total number of entries 104 in each bucket 102a-102n would be 16. Therefore, candidate filter data structure 100 can comprise 1,048,576 buckets 102, for a total number of entries 104 of 16,777,216. If an entire 32 byte signature was to be stored in each entry 104, the total number of entries would decrease by a factor of 8. Therefore, for data objects which are 8 KiB in size, candidate filter data structure 100 has an addressable filter capacity of 128 GiB. Assuming that the cache itself is 1GiB, allocating an additional 64 MiB for candidate filter data structure 100 would result in 128 times the number of candidates compared to cache spots. Accordingly, greater selectiveness can be used in caching data objects and the rate of poor candidates evicting potentially good candidates before the good candidates have a chance for promotion is reduced.

As previously indicated, the above example was for illustrative purposes and should not be interpreted as limiting the scope of the present disclosure. The parameters selected were chosen to assist in illustrating the benefits of the embodiments disclosed herein and should not be interpreted as setting any limit or threshold on the parameters for which the embodiments disclosed herein are applicable.

The overall increase in capacity for candidates is dependent on the ability of candidate filter data structure 100 to provide the requisite capacity without the number of filter collisions impacting performance of the cache. Acceptable collision rates can vary depending on the application. Moreover, the rate of collisions is dependent on the hashing algorithm used to generate object signature 106. As a non-limiting example, where SHA-2 is used to generate the object signature 106, the SHA-2 standard accounts for a collision rate of the number of bits divided by 2 (numBits/2). Using the non-limiting example discussed above, a total of 52 bits of uniqueness is available from candidate filter data structure 100. Each entry 104a-104n allows for 32 bits of uniqueness. Another 20 bits of uniqueness are provided by the first portion 106a. As shown above, the number of buckets is a power-of-two number (i.e., 1,048,576=2²⁰). In such situations, it is possible to infer that the number of bits required to identify the bucket 102a (or any bucket 102) corresponds to the least significant bits (in this example, 20 bits). In various embodiments, a similar inference can be made where modulo division is used for a non-power-of-two number of buckets 102. Accordingly, candidate filter data structure 100 in this example provides 26 bits of collision resistance, which estimates to roughly one collision every 64 million entries. This is much greater than the roughly 16 million entries in candidate filter data structure 100. Therefore, even though the entire object signature 106 is not stored as an entry 104, the candidate filter 104 still provides sufficient uniqueness that the probability of a filter collision is low. In various embodiments, the bits of collision resistance may be different for different hashing algorithms used to generate the object signature 106.

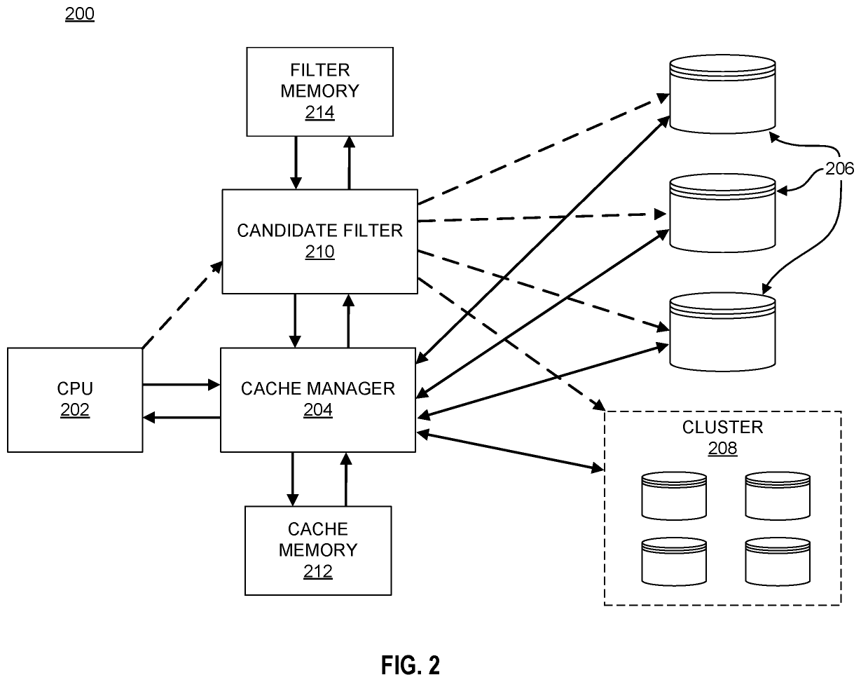

FIG. 2 illustrates an example system 200 in accordance with embodiments of the technology disclosed herein. Elements identified with the same reference character as other figures should be interpreted to be the same and the corresponding discussion also applies. As illustrated in FIG. 2, the system 200 includes a central processing unit (CPU) 202. In various embodiments, the CPU 202 can comprise one or more processing components, such as the processing components discussed below with respect to FIG. 5.

CPU 202 is communicatively coupled to cache manager 204. Cache manager 204 may be a software component executing on a hardware processing resource and tasked with managing the operation of the cache stored in a cache memory 212. In some embodiments, cache manager 204 may manage one or more cache memories 212, while in other embodiments a separate cache manager 204 may be used for each of one or more cache memories 212. In various embodiments, cache memory 212 is static random access memory (SRAM), synchronous dynamic RAM (SDRAM), non-volatile RAM (NVRAM), embedded dynamic RAM (eDRAM), SSD, or any other memory component currently available, or those developed hereafter, for use as cache memory. Cache manager 204 is connected with one or more storage devices 206. In various embodiments, the storage devices 206 can be one or more of dynamic RAM (DRAM), storage servers, a logical unit number (LUN), hard disk drives (HDD), or other storage devices. In some embodiments, cache manager 204 can be connected with a cluster 208. In various embodiments, cache manager 204 can send and receive data objects to and from storage device 206 and/or cluster 208. A person of ordinary skill in the art would know the type of storage architecture does not impact the applicability of the embodiments.

System 200 further includes a candidate filter 210. In various embodiments, candidate filter 210 is a software component executing on a hardware processing resource and tasked with tracking data object requests and managing a filter data structure, such as candidate data structure 100 discussed above with respect to FIG. 1. Candidate filter 210 performs the various functions discussed above with respect to candidate data structure 100, including identifying buckets 102 and entries 104, computing the hashes, and storing and/or evicting the content of entries 104. In various embodiments, candidate filter 210 may be connected with one or more cache managers 204. In such embodiments, candidate filter 210 may be configured to manage a different candidate data structure 100 for each cache manager 204, while in other embodiments a single candidate data structure 100 may be used by the candidate filter 210 to track access requests sent to each of the one or more cache managers 204.

Candidate filter 210 is connected with filter memory 214, which stores candidate data structure 100. In various embodiments, filter memory 214 may be static random access memory (SRAM), synchronous dynamic RAM (SDRAM), non-volatile RAM (NVRAM), embedded dynamic RAM (eDRAM), SSD, or any other memory component currently available, or those developed hereafter, suitable for use at the cache level. Although illustrated as separate memories, in some embodiments cache memory 212 and filter memory 214 may be combined into a single memory. In various embodiments, the single memory may be partitioned into a cache memory 212 portion and a filter memory 214 portion. In various embodiments, cache memory 212 and/or filter memory 214 may be implemented on a plurality of memories, the plurality of memories comprising one or more of the types of memory discussed above.

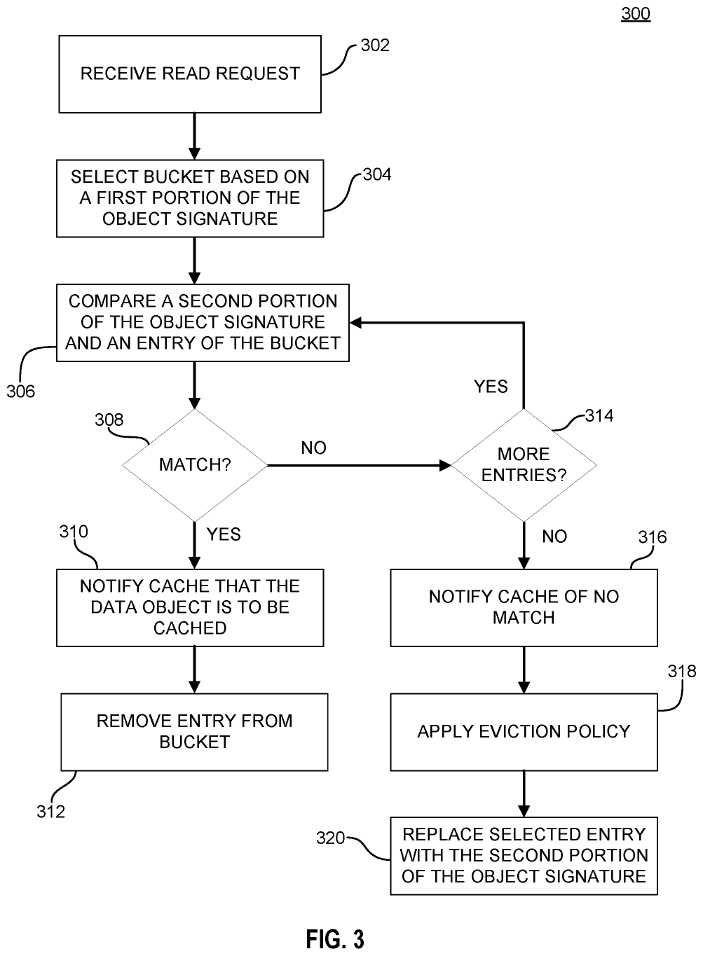

When cache manager 204 receives a read request from CPU 202 in various embodiments, cache manager 204 may send the request to candidate filter 210 to determine whether the data object was previously requested. In some embodiments, cache manager 204 may send the full request (including the object signature) to candidate filter 210. Cache manager 204 may send only the object signature contained within the request to candidate filter 210 in other embodiments. Upon receipt of the object signature from cache manager 204, candidate filter 210 checks candidate filter data structure 100 in the filter memory 214 to determine whether the data object was previously requested, based on the object signature. The checking process performed by candidate filter 210 using candidate data structure 100 may be similar to the process discussed above with respect to FIG. 1 and explained in more detail below with respect to FIG. 3. If candidate filter 210 finds a match within candidate data structure 100, candidate filter 210 may send a notification to cache manager 204, informing cache manager 204 that the data object was recently requested. After receiving the notification, cache manager 204 may cache the data object (i.e., fetch the data object from its location in one or more of the storage devices 206 and/or clusters 208). After sending the notification, candidate filter 210 may remove the second portion of the object signature stored in the matched entry of candidate data structure 100. If no match is found, the candidate filter 210 sends cache manager 204 a notification that no match was found, and candidate filter 210 stores a second portion of the requested object signature as an entry in the bucket of the candidate data structure 100 identified by a first portion of the object signature. In various embodiments, candidate filter 210 may apply an eviction policy to find an open entry for the second portion of the object signature when all the entries in the identify bucket of candidate data structure 100 is full.

In various embodiments, candidate filter 210 may also be connected with data storage devices 206 and/or cluster 208, shown by the dashed lines in FIG. 2. In various embodiments, the connection between candidate filter 210 is unidirectional (from candidate filter 210 to storage devices 206 and/or cluster 208). In other embodiments, the connection between candidate filter 210, storage devices 206, and/or cluster 208 may be bidirectional. CPU 202 may also send requests to the candidate filter 210 directly over a unidirectional connection.

In various embodiments, the candidate selection can be further enhanced to enable prioritized selection. For example, in systems with a number of different clients (e.g., a hyperconverged device), each client can be assigned a priority. When selecting a candidate for promotion, an entry counter can be included in each entry of candidate data structure 100 and be incremented by candidate filter 210 each time the stored value of that entry is matched with a portion of an object signature. Depending on the priority assigned to the client, a threshold on the number of requests required before the candidate is selected for promotion can be applied. In various embodiments, prioritized selection may be based on levels of service defined in a service level agreement (SLA) or other service contract. The entry counter may comprise an extra bit for each entry in various embodiments.

As a non-limiting example, clients can be assigned either Gold, Silver, or Bronze, with Gold-level signatures being promoted after a count of 1, Silver-level signatures promoted after a count of 2, and Bronze-level signatures promoted after a count of 3. In this way, data objects associated with Gold-level priority will be promoted sooner than data objects associated with Silver-level priority so that Gold-level clients receive increased service and performance. In addition to using priorities to determine when to promote a data object, the candidate filter 210 can account for priority level in determining whether to evict an entry.

In various embodiments, more granularity can be used for the priority levels. In some embodiments, the thresholds may include greater differences between the number of counts before promotion. A second counter can be included in some embodiments to allow for two different thresholds to be applied—a promotion threshold and an eviction threshold.

Cache manager 204 and/or candidate filter 210 discussed above may be implemented by non-transitory machine-readable instructions executed by a processor. In some embodiments, the processor may be CPU 202. In other embodiments, the processor executing the functions may be a co-processor associated with CPU 202 or a separate dedicated processor. In still further embodiments, cache manager 204 and/or candidate filter 210 may be embodied in hardware, such as an application specific integrated circuit (ASIC), field-programmable gate array (FPGA), or other hardware.

FIG. 3 shows an example process 300 in accordance with embodiments of the technology of the present disclosure. At operation 302, the candidate filter receives a read request. In various embodiments, the request can be received from a cache manager, like cache manager 204 discussed with respect to FIG. 2. In other embodiments, the request may be received from the CPU.

At operation 304, the candidate filter selects a bucket of a candidate data structure based on a first portion of the object signature of the requested data object. In various embodiments, selecting the bucket may be similar to the selection of a bucket 102 of candidate filter 100 discussed above with respect to FIGS. 1 and 2. In various embodiments, the first portion can comprise a set number of bytes of the object signature. Selecting the bucket can comprise computing a value based on the first portion of the object signature. In various embodiments, the bucket selection may be made by performing a modulo operation using the number of buckets of the candidate data structure, the set number of bytes of the object signature (i.e., the first portion) serving as the dividend.

After a bucket is selected, the candidate filter compares a second portion of the object signature with the entries in the selected bucket of the candidate data structure at operation 304. The second portion comprises a different set of bytes of the object signature in some embodiments, while in other embodiments the second portion and the first portion may include one or more common bytes. The number of bytes comprising the second portion may be less than, the same as, or more than the first portion. In various embodiments, the candidate filter may retrieve the entries of the selected buck of the candidate data structure from a filter memory. The candidate filter iterates through the entries of the selected bucket to compare the second portion of the object signature to the value in the entry.

If a match is found at 308, the candidate filter notifies the cache manager of the match at operation 310. In various embodiments, the notification may be a return value of “true” to the cache manager. In other embodiments, the notification may be a message to the cache manager stating that a match was found. After notifying the cache manager of the match, the candidate filter removes the second portion of the signature from the entry in the bucket of the candidate data structure. Once removed, the entry is marked empty and is ready for the candidate filter to store another value.

If no match is found at operation 308, the candidate filter determines at operation 314 whether there are any other entries of the selected bucket left with which to compare the second portion. If there are more entries, the process 300 iterates back to operation 306 to run the comparison again. The candidate filter will continue to iterate through the bucket of the candidate data structure until all entries have been checked.

If it is determined at operation 314 that there are no more entries left, the candidate filter notifies the cache manager that no match was found at operation 316. In various embodiments, the notification at operation 316 can be performed in a similar manner to the notification discussed with respect to operation 310.

After notifying the cache manager of no matching entry being found, the candidate filter may apply an eviction policy on the candidate data structure at operation 318. In various embodiments, the eviction policy may include checking to see whether there is an open entry in the selected bucket. If there is an open entry, the candidate filter may terminate application of the eviction policy without evicting any values stored in the candidate data structure. If all of the entries are filled, the candidate filter uses the eviction policy to find an entry within the bucket of the candidate data structure in which to store the second portion of the object signature used in the comparison at operation 306. The eviction policy can be one of the eviction policies discussed above with respect to FIG. 1, or any other eviction policy used with memory caches. Once a free entry is determined, whether an open entry or a freed entry through the eviction policy, the candidate filter replaces the value in the entry with the second portion of the object signature at operation 320.

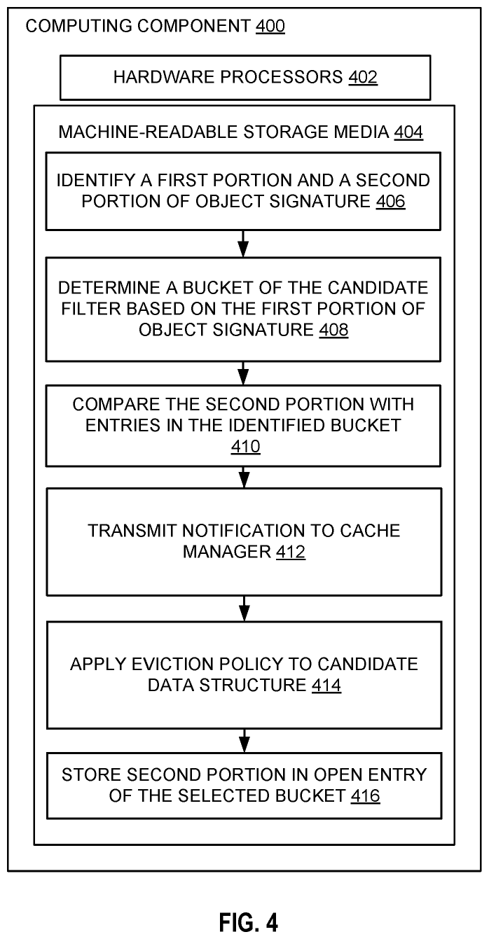

FIG. 4 is an example computing component 400 in accordance with embodiments of the present disclosure. Where operations and functionality of computing device 400 are similar to those discussed with respect to FIGS. 1-3, the description should be interpreted to apply. In various embodiments, the computing component 400 may be a server or other device utilizing cache memory and implementing candidate filter 210 and candidate data structure 100 discussed with respect to FIGS. 1-3. Computing component 400 includes hardware processors 402. In various embodiments, hardware processors 402 may be similar to the processors discussed below with respect to FIG. 5. In various embodiments, hardware processors 402 may include one or more processors.

Hardware processors 402 are configured to execute instructions stored on a machine-readable medium 404. Machine readable medium 404 may be one or more types of non-transitory computer storage mediums. Non-limiting examples include: flash memory, solid state storage devices (SSDs); a storage area network (SAN); removable memory (e.g., memory stick, CD, SD cards, etc.); or internal computer RAM or ROM; among other types of computer storage mediums. The instructions stored on the machine-readable medium 404 may include various sub-instructions for performing the function embodied by the identified functions. For example, the instruction “Identify a First Portion and a Second Portion of Object Signature” 408 may include various sub-instructions for determining the first and second portion of the object signature in a manner similar to that discussed with respect to FIGS. 1-3.

The instruction “Determine a Bucket of the Candidate Filter Based on the First Portion of Object Signature” 406 may include various sub-instructions for identifying the first portion of the object signature of a requested data object and computing a bucket number of a candidate data structure in a manner similar to the bucket identification discussed with respect to FIGS. 1-3.

The instruction “Compare the Second Portion With Entries in the Identified Bucket” 410 may include sub-instructions to cause the candidate filter to iterate through the entries within a selected bucket of the candidate data structure and compare the values in the entries with the second portion of the object signature, in a manner similar to that discussed with respect to FIGS. 1-3.

The instruction “Transmit Notification to Cache Manager” 412 may include sub-instructions to send a notification to the cache manager whether a match was or was not found, in a manner similar to that discussed with respect to FIGS. 1-3. The instruction “Apply Eviction Policy to Candidate Data Structure” 414 may include sub-instructions to cause the candidate filter to identify an entry of the candidate data structure and remove the current value of the entry in a manner similar to the eviction policies discussed with respect to FIGS. 1-3. In various embodiments, instruction “Apply Eviction Policy to Candidate Data Structure” 414 may include sub-instructions to cause the candidate filter to identify whether all the entries of the candidate data structure are filled or if there is an empty entry with a null or no value.

The instruction “Store Second Portion in Open Entry of the Selected Bucket” 416 may include sub-instructions to store the second portion of the object signature in the open entry of the selected bucket in a manner similar to that discussed with respect to FIGS. 1-3.

FIG. 5 depicts a block diagram of an example computer system 500 in which various of the embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors. In various embodiments, the one or more hardware processors 504 may execute non-transitory machine-readable instructions to perform the various functions of the embodiments discussed with respect to FIGS. 1-4.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions. In various embodiments, the main memory 506 can include the candidate data structure 100 discussed with respect to FIG. 1.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may further include a display 512, input device 514, and/or a cursor control 516 coupled to bust 502 for displaying, communicating, and entering information and/or commands. In some embodiments, the same direction information and command selections as cursor control may be implemented via receiving touches on a touch screen without a cursor. The computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. In various embodiments, such instructions may be similar to those discussed with respect to FIG. 4. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media can also take the form of acoustic or light waves, such as those generated during radio-wave and infra-red data communications.

The computer system 500 also includes a communication interface 518 coupled to bus 502 for enabling two way communication with one or more networks over one or more network links. For example, communication interface 518 may be an integrated services digital network (ISDN) card, cable modem, satellite modem, a modem to provide a data communication connection to a corresponding type of telephone line, a local area network (LAN), a wide area network, or one or more types of wireless communication links.

The computer system 500 can send messages and receive data, including program code, through the network(s), network link and communication interface 518. In the Internet example, a server might transmit a requested code for an application program through the Internet, the ISP, the local network and the communication interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 500.

In common usage, the term “or” should always be construed in the inclusive sense unless the exclusive sense is specifically indicated or logically necessary. The exclusive sense of “or” is specifically indicated when, for example, the term “or” is paired with the term “either,” as in “either A or B.” As another example, the exclusive sense may also be specifically indicated by appending “exclusive” or “but not both” after the list of items, as in “A or B, exclusively” and “A and B, but not both.” Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method, comprising:
identifying a first portion and a second portion of an object signature by a candidate filter;
determining, by the candidate filter, a bucket of a candidate data structure to associate with the object signature based on a first portion of the object signature;
comparing, by the candidate filter, the second portion of the object signature to each of a plurality of entries of the determined bucket of the candidate data structure; and
in response to determining no entry of the plurality of entries matches the second portion of the signature, the candidate filter storing the second portion of the object signature in an open entry of the determined bucket.

2. The method of claim 1, wherein the first portion comprises a first subset of bytes of the object signature and the second portion comprises a subset of second subset of bytes of the object signature.

3. The method of claim 2, wherein the first subset of bytes is exclusive of the second subset of bytes.

4. The method of claim 1, wherein determining the bucket of the candidate data structure comprises the candidate filter computing a bucket number based on the first portion of the object signature.

5. The method of claim 4, wherein computing the bucket number comprises applying a modulo function to the first portion of the object signature and a total number of buckets of the candidate data structure.

6. The method of claim 1, wherein each entry of a plurality of entries of the candidate data structure store a plurality of bytes less than a number of bytes comprising the object signature.

7. The method of claim 1, further comprising sending, by the candidate filter, a notification to a cache manager indicting no entry of the plurality of entries matches the second portion of the object signature.

8. The method of claim 1, wherein in response to determining an entry of the plurality of entries matches the second portion of the signature:
sending, by the candidate filter, a notification to a cache manager that a match was found; and
removing a value in the determined entry of the candidate data structure.

9. A system, comprising:
a processor;
a cache memory communicatively coupled to the processor;
a filter memory communicatively coupled to the processor; and
a non-transitory machine-readable storage device storing instructions that when executed by the processor causes the processor to:
identify a first portion and a second portion of an object signature;
determine a bucket of a candidate data structure to associate with the object signature based on a first portion of the object signature;
compare the second portion of the object signature to each of a plurality of entries of the determined bucket in the candidate data structure; and
in response to determining no entry of the plurality of entries matches the second portion of the signature, store the second portion of the object signature in an open entry of the determined bucket.

10. The system of claim 9, wherein the cache memory and the filter memory are combined into a single cache memory component.

11. The system of claim 9, wherein the first portion comprises a first subset of bytes of the object signature and the second portion comprises a subset of second subset of bytes of the object signature, and the first subset of byte is exclusive of the second subset of bytes.

12. The system of claim 9, wherein determine the bucket of the candidate data structure comprises computing a bucket number based on the first portion of the object signature.

13. The system of claim 12, wherein computing the bucket number comprises applying a modulo function to the first portion of the object signature and a total number of buckets of the candidate data structure.

14. The system of claim 9, wherein each entry of a plurality of entries of the candidate data structure store a plurality of bytes less than a number of bytes comprising the object signature.

15. The system of claim 9, wherein each entry of the candidate data structure includes an entry counter, and further comprising instructions that when executed cause the processor to, in response to determining an entry of the plurality of entries matches the second portion of the signature:
send a notification to the cache manager that a match was found; and
increment the entry counter.

16. The system of claim 9, further comprising instructions that when executed cause the processor to, in response to determining an entry of the plurality of entries matches the second portion of the signature:
send a notification to the cache manager that a match was found;
promote a data object associated with the object signature to the cache memory; and
remove a value in the determined entry.

17. The system of claim 16, wherein the instruction send a notification to the cache manager comprises:
determine a priority level associated with the entry of the plurality of entries matching the second portion of the signature;
identify a promotion threshold associated with the entry of the plurality of entries, the promotion threshold comprising a total number of matches required before promotion of the data object associated with the object signature which matches the entry is promoted to the cache memory based on the priority level;
compare an entry counter against a promotion threshold, the entry counter associated with the entry identifying a number of matches determined for the entry;
in response to determining the entry counter exceeds the promotion threshold associated with the entry, send the notification to the cache manager that a match was found; and
in response to determining the entry counter does not exceed the promotion threshold associated with the entry, increment the entry counter.

18. A non-transitory machine-readable storage media comprising instructions that when executed by a processor cause the processor to:
identify a first portion and a second portion of an object signature;
determine a bucket of a candidate data structure to associate with the object signature based on a first portion of the object signature;
compare the second portion of the object signature to each of a plurality of entries of the determined bucket; and
in response to determining no entry of the plurality of entries matches the second portion of the signature, store the second portion of the object signature in an open entry of the determined bucket.

19. The non-transitory machine-readable storage media of claim 18, wherein determine the bucket of the candidate data structure comprises computing a bucket number as the first portion of the object signature modulo a total number of buckets of the candidate data structure.

20. The non-transitory machine-readable storage media of claim 18, wherein each entry of a plurality of entries of the candidate data structure store a plurality of bytes less than a number of bytes comprising the object signature.
